(19) United States
(12) Patent Application Publication
(10) Pub. No.: US 2015/0366189 A1
(43) Pub. Date: Dec. 24, 2015

(54) DRY MELT COATING PROCESS AND FORMULATION FOR VOLATILE COMPOUNDS

(71) Applicants: Christian Guy BECKER, (US); AGROFRISH INC., Collegeville, PA (US)

(72) Inventor: Christian Guy Becker, King of Prussia, PA (US)

(21) Appl. No.: 14/765,049

(22) PCT Filed: Feb. 6, 2014
(86) PCT No.: PCT/US2014/015085

§ 371 Date: Jul. 31, 2015

Related U.S. Application Data
(60) Provisional application No. 61/762,512, filed on Feb. 8, 2013.

(51) Int. Cl. A01N 25/28; A01N 27/00; B05D 1/02

(52) U.S. Cl. CPC A01N 25/28; B05D 1/02; A01N 27/00

(57) ABSTRACT

This invention is based on surprising results that dry-coat particles using a melt process where the dispersed melted polymer core (for example a linear polyester diol containing dispersed HAIP) can bead up effectively in a surrounding hydrophobic powder. One good coating powder is identified as organoclay. Silica coating also works well when combined with clay coating. With the coating provided, this invention enables generation of a stable powder with, for example approximately 20%, HAIP loading using a simple grinding and sieving process. The formulations provided can release less than 25% 1-MCP over a period of 4 hours under stirring conditions.

### BACKGROUND OF THE INVENTION

Volatile compounds such as 1-Methylcyclopropene (1-MCP) can be caged in cyclodextrin and the resulting product is a complex called High Active Ingredient Product (or HAIP in short) in the case of 1-MCP. HAIP contains on average a concentration of 4.5% 1-MCP. HAIP is composed of long crystals not amenable to suspension due to their large size (up to 100-150 μm in length). However, certain air milled product can be generated with an average particle size around 3-5 μm (microns).

Since HAIP releases 1-MCP fast when in contact with water, creating a formulation that could be water tank mixed is obviously a challenge. Also, from a safety point of view, the release of 1-MCP which is flammable above a concentration threshold of 13,300 ppm is a problem in enclosed space (i.e., sealed water tank). It is therefore advisable (for safety and legal considerations) that 1-MCP released, when mixed in an agitated tank at a typical application rate over a period of 4 to 6 hours, should not exceed 25% of its flammability limit to be acceptable. It can be estimated that a 1-MCP release rate in water close to 20% over a 4 hour period should meet this criteria based on application rate.

Many approaches, where the product was encapsulated either in liquid or solid matrices (obtained using various processes) were tried with limited success. Therefore, there remains a need to develop new formulations for volatile compounds such as 1-MCP which can be applied via a tank spray application mode.

### SUMMARY OF THE INVENTION

This invention is based on surprising results that dry-coat particles using a melt process where the dispersed melted polymer core (for example a linear polyester diol containing dispersed HAIP) can bead up effectively in a surrounding hydrophobic powder. One good coating powder is identified as organoclay. Silica coating also works well when combined with clay coating. With the coating provided, this invention enables generation of a stable powder with, for example approximately 20%, HAIP loading using a simple grinding and sieving process. The formulations provided can release less than 25% 1-MCP over a period of 4 hours under stirring conditions.

In one aspect, provided is a dry melt method for coating particles. The method comprises (a) providing a melted core resin; (b) mixing the melted core resin with active ingredient particles to generate a mixture, wherein the active ingredient comprises a volatile compound; and (c) mixing the mixture of step (b) with particles of at least one coating material to generate a coated product.

In one embodiment, the method further comprises grinding the mixture of step (b) into a powder with a set size; and re-melting the mixture. In a further embodiment, the set size is from 50 μm to 300 μm. In another embodiment, the set size is from 100 μm to 250 μm. In another embodiment, the set size is from 150 μm to 250 μm.

In another embodiment, the method further comprises cooling down the coated product to form a coated solid particle. In another embodiment, the method further comprises recovering the coated product or coated solid particle by sieving.

In another embodiment, the core resin is selected from the group consisting of a polyester, a polyether, an epoxy resin, an isocyanate, an organic amine, an ethylene vinyl acetate copolymer, a natural or synthesized wax, and combinations thereof. In another embodiment, the core resin comprises a linear polyester diol. In another embodiment, the core resin has a melting point from about 50° C. to 100° C. In another embodiment, the core resin has a melting point from about 50° C. to 70° C. In another embodiment, the core resin has a melting point from about 50° C. to 60° C.

In another embodiment, the active ingredient particles comprise a cyclopropene molecular complex and the cyclopropene molecular complex comprises a cyclopropene compound and a molecular encapsulating agent. In another embodiment, the volatile compound comprises a cyclopropene compound. In another embodiment, the molecular encapsulating agent is selected from the group consisting of alpha-cyclodextrin, beta-cyclodextrin, gamma-cyclodextrin, and combinations thereof. In another embodiment, the molecular encapsulating agent comprises alpha-cyclodextrin.

In another embodiment, the cyclopropene compound is of the formula:

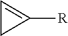

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

In a further embodiment, R is C₁₋₈ alkyl. In another embodiment, R is methyl.

In another embodiment, the cyclopropene compound is of the formula:

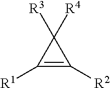

wherein R¹ is a substituted or unsubstituted C₁-C₄ alkyl, C₁-C₄ alkenyl, C₁-C₄ alkynyl, C₁-C₄ cycloalkyl, cylcoalkylalkyl, phenyl, or napthyl group; and R², R³, and R⁴ are hydrogen.

In a further embodiment, the cyclopropene comprises 1-methylcyclopropene (1-MCP). In another embodiment, the coating material comprises a silica particle. In another embodiment, the coating material comprises an organoclay. In another embodiment, the coating material comprises a silica particle and an organoclay. In another embodiment, the coating material comprises a combination of a silica particle and an organoclay, i.e., a silica-organoclay combination as coating material.

In another aspect, provided is a collection of coated solid particles prepared by the method provided herein. In one embodiment, release rate of the volatile compound after four hours upon contact of a solvent is reduced at least two folds as compared to solid particles without coating. In another embodiment, release rate of the volatile compound after four hours upon contact of a solvent is reduced from two folds to five folds as compared to solid particles without coating. In another embodiment, less than 25% of the volatile compound is released after four hours upon contact of a solvent. In another embodiment, from 10% to 25% of the volatile compound is released after four hours upon contact of a solvent. In another embodiment, the solvent comprises water.

In another aspect, provided is a method of inhibiting an ethylene response in a plant, or a method of treating plant or plant parts. The method comprising applying to the plant with a composition comprising the collection of coated solid particles provided herein. In one embodiment, the applying comprises spraying. In another embodiment, the composition is a liquid composition comprising suspension of the collection of coated solid particles.

### BRIEF DESCRIPTION OF THE DRAWINGS

FIG. 1 shows a representative comparison of particle shapes to influence on water penetration.

FIG. 2 shows a representative process for melting and sieving to isolate the coated particles.

FIG. 3 shows representative results for influence of surfactant wetting on release rate.

FIG. 4 shows representative results for silica coating of 20% HAIP in CAPA® 2304 (release in water with 1% surfactant).

### DETAILED DESCRIPTION OF THE INVENTION

The volatile compounds of the subject invention may comprise a cyclopropene compound. As used herein, a cyclopropene compound is any compound with the formula

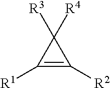

where each R¹, R², R³ and R⁴ is independently selected from the group consisting of H and a chemical group of the formula:

-(L)ₙ-Z

where n is an integer from 0 to 12. Each L is a bivalent radical. Suitable L groups include, for example, radicals containing one or more atoms selected from H, B, C, N, O, P, S, Si, or mixtures thereof. The atoms within an L group may be connected to each other by single bonds, double bonds, triple bonds, or mixtures thereof. Each L group may be linear, branched, cyclic, or a combination thereof. In any one R group (i.e., any one of R¹, R², R³ and R⁴) the total number of heteroatoms (i.e., atoms that are neither H nor C) is from 0 to 6. Independently, in any one R group the total number of non-hydrogen atoms is 50 or less. Each Z is a monovalent radical. Each Z is independently selected from the group consisting of hydrogen, halo, cyano, nitro, nitroso, azido, chlorate, bromate, iodate, isocyanato, isocyanido, isothiocyanato, pentafluorothio, and a chemical group G, wherein G is a 3 to 14 membered ring system.

The R¹, R², R³, and R⁴ groups are independently selected from the suitable groups. The R¹, R², R³, and R⁴ groups may be the same as each other, or any number of them may be different from the others. Among the groups that are suitable for use as one or more of R¹, R², R³, and R⁴ are, for example, aliphatic groups, aliphatic-oxy groups, alkylphosphonato groups, cycloaliphatic groups, cycloalkylsulfonyl groups, cycloalkylamino groups, heterocyclic groups, aryl groups, heteroaryl groups, halogens, silyl groups, other groups, and mixtures and combinations thereof. Groups that are suitable for use as one or more of R¹, R², R³, and R⁴ may be substituted or unsubstituted. Independently, groups that are suitable for use as one or more of R¹, R², R³, and R⁴ may be connected directly to the cyclopropene ring or may be connected to the cyclopropene ring through an intervening group such as, for example, a heteroatom-containing group.

Among the suitable R¹, R², R³, and R⁴ groups are, for example, aliphatic groups. Some suitable aliphatic groups include, but are not limited to, alkyl, alkenyl, and alkynyl groups. Suitable aliphatic groups may be linear, branched, cyclic, or a combination thereof. Independently, suitable aliphatic groups may be substituted or unsubstituted.

As used herein, a chemical group of interest is said to be “substituted” if one or more hydrogen atoms of the chemical group of interest is replaced by a substituent. It is contemplated that such substituted groups may be made by any method, including but not limited to making the unsubstituted form of the chemical group of interest and then performing a substitution. Suitable substituents include, but are not limited to, alkyl, alkenyl, acetylamino, alkoxy, alkoxyalkoxy, alkoxycarbonyl, alkoxyimio, carboxy, halo, haloalkoxy, hydroxy, alkylsulfonyl, alkylthio, trialkylsilyl, dialkylamino, and combinations thereof. An additional suitable substituent, which, if present, may be present alone or in combination with another suitable substituent, is

-(L)ₘ-Z

where m is 0 to 8, and where L and Z are defined herein above. If more than one substituent is present on a single chemical group of interest, each substituent may replace a different hydrogen atom, or one substituent may be attached to another substituent, which in turn is attached to the chemical group of interest, or a combination thereof.

Among the suitable R¹, R², R³, and R⁴ groups are, without limitation, substituted and unsubstituted aliphatic-oxy groups, such as, for example, alkenoxy, alkoxy, alkynoxy, and alkoxycarbonyloxy.

Also among the suitable R¹, R², R³, and R⁴ groups are, without limitation, substituted and unsubstituted alkylphosphonato, substituted and unsubstituted alkylphosphato, substituted and unsubstituted alkylamino, substituted and unsubstituted alkylsulfonyl, substituted and unsubstituted alkylcarbonyl, and substituted and unsubstituted alkylaminosulfonyl, including, without limitation, alkylphosphonato, dialkylphosphato, dialkylthiophosphato, dialkylamino, alkylcarbonyl, and dialkylaminosulfonyl.

Also among the suitable R¹, R², R³, and R⁴ groups are, without limitation, substituted and unsubstituted cycloalkylsulfonyl groups and cycloalkylamino groups, such as, for example, dicycloalkylaminosulfonyl and dicycloalkylamino.

Also among the suitable R¹, R², R³, and R⁴ groups are, without limitation, substituted and unsubstituted heterocyclyl groups (i.e., aromatic or non-aromatic cyclic groups with at least one heteroatom in the ring).

Also among the suitable R¹, R², R³, and R⁴ groups are, without limitation, substituted and unsubstituted heterocyclyl groups that are connected to the cyclopropene compound through an intervening oxy group, amino group, carbonyl group, or sulfonyl group; examples of such R¹, R², R³, and R⁴ groups are heterocyclyloxy, heterocyclylcarbonyl, diheterocyclylamino, and diheterocyclylaminosulfonyl.

Also among the suitable R¹, R², R³, and R⁴ groups are, without limitation, substituted and unsubstituted aryl groups. Suitable substituents include those described herein above. In some embodiments, one or more substituted aryl group may be used in which at least one substituent is one or more of alkenyl, alkyl, alkynyl, acetylamino, alkoxyalkoxy, alkoxy, alkoxycarbonyl, carbonyl, alkylcarbonyloxy, carboxy, arylamino, haloalkoxy, halo, hydroxy, trialkylsilyl, dialkylamino, alkylsulfonyl, sulfonylalkyl, alkylthio, thioalkyl, arylaminosulfonyl, and haloalkylthio.

Also among the suitable R¹, R², R³, and R⁴ groups are, without limitation, substituted and unsubstituted heterocyclic groups that are connected to the cyclopropene compound through an intervening oxy group, amino group, carbonyl group, sulfonyl group, thioalkyl group, or aminosulfonyl group; examples of such R¹, R², R³, and R⁴ groups are diheteroarylamino, heteroarylthioalkyl, and diheteroarylaminosulfonyl.

Also among the suitable R¹, R², R³, and R⁴ groups are, without limitation, hydrogen, fluoro, chloro, bromo, iodo, cyano, nitro, nitroso, azido, chlorato, bromato, iodato, isocyanato, isocyanido, isothiocyanato, pentafluorothio; acetoxy, carboethoxy, cyanato, nitrato, nitrito, perchlorato, allenyl; butylmercapto, diethylphosphonato, dimethylphenylsilyl, isoquinolyl, mercapto, naphthyl, phenoxy, phenyl, piperidino, pyridyl, quinolyl, triethylsilyl, trimethylsilyl; and substituted analogs thereof.

As used herein, the chemical group G is a 3 to 14 membered ring system. Ring systems suitable as chemical group G may be substituted or unsubstituted; they may be aromatic (including, for example, phenyl and napthyl) or aliphatic (including unsaturated aliphatic, partially saturated aliphatic, or saturated aliphatic); and they may be carbocyclic or heterocyclic. Among heterocyclic G groups, some suitable heteroatoms are, without limitation, nitrogen, sulfur, oxygen, and combinations thereof. Ring systems suitable as chemical group G may be monocyclic, bicyclic, tricyclic, polycyclic, spiro, or fused; among suitable chemical group G ring systems that are bicyclic, tricyclic, or fused, the various rings in a single chemical group G may be all the same type or may be of two or more types (for example, an aromatic ring may be fused with an aliphatic ring).

In some embodiments, G is a ring system that contains a saturated or unsaturated 3 membered ring, such as, without limitation, a substituted or unsubstituted cyclopropane, cyclopropene, epoxide, or aziridine ring.

In some embodiments, G is a ring system that contains a 4 membered heterocyclic ring; in some of such embodiments, the heterocyclic ring contains exactly one heteroatom. In some embodiments, G is a ring system that contains a heterocyclic ring with 5 or more members; in some of such embodiments, the heterocyclic ring contains 1 to 4 heteroatoms. In some embodiments, the ring in G is unsubstituted; in other embodiments, the ring system contains 1 to 5 substituents; in some embodiments in which G contains substituents, each substituent may be independently chosen from the substituents described herein above. Also suitable are embodiments in which G is a carbocyclic ring system.

In some embodiments, each G is independently a substituted or unsubstituted phenyl, pyridyl, cyclohexyl, cyclopentyl, cycloheptyl, pyrolyl, furyl, thiophenyl, triazolyl, pyrazolyl, 1,3-dioxolanyl, or morpholinyl. Among these embodiments are included those embodiments, for example, in which G is unsubstituted or substituted phenyl, cyclopentyl, cycloheptyl, or cyclohexyl. In some embodiments, G is cyclopentyl, cycloheptyl, cyclohexyl, phenyl, or substituted phenyl. Among embodiments in which G is substituted phenyl are embodiments, without limitation, in which there are 1, 2, or 3 substituents. In some embodiments in which G is substituted phenyl are embodiments, without limitation, in which the substituents are independently selected from methyl, methoxy, and halo.

Also contemplated are embodiments in which R³ and R⁴ are combined into a single group, which may be attached to the number 3 carbon atom of the cyclopropene ring by a double bond. Some of such compounds are described in US Patent Publication 2005/0288189.

In some embodiments, one or more cyclopropenes may be used in which one or more of R¹, R², R³, and R⁴ is hydrogen. In some embodiments, R¹ or R² or both R¹ and R² may be hydrogen. In some embodiments, R³ or R⁴ or both R³ and R⁴ may be hydrogen. In some embodiments, R², R³, and R⁴ may be hydrogen.

In some embodiments, one or more of R¹, R², R³, and R⁴ may be a structure that has no double bond. Independently, in some embodiments, one or more of R¹, R², R³, and R⁴ may be a structure that has no triple bond. In some embodiments, one or more of R¹, R², R³, and R⁴ may be a structure that has no halogen atom substituent. In some embodiments, one or more of R¹, R², R³, and R⁴ may be a structure that has no substituent that is ionic.

In some embodiments, one or more of R¹, R², R³, and R⁴ may be hydrogen or (C₁-C₁₀) alkyl. In some embodiments, each of R¹, R², R³, and R⁴ may be hydrogen or (C₁-C₈) alkyl. In some embodiments, each of R¹, R², R³, and R⁴ may be hydrogen or (C₁-C₄) alkyl. In some embodiments, each of R¹, R², R³, and R⁴ may be hydrogen or methyl. In some embodiments, R¹ may be (C₁-C₄) alkyl and each of R², R³, and R⁴ may be hydrogen. In some embodiments, R¹ may be methyl and each of R², R³, and R⁴ may be hydrogen, and the cyclopropene is known herein as “1-methylcyclopropene” or “1-MCP.”

In some embodiments, a cyclopropene may be used that has boiling point at one atmosphere pressure of 50° C. or lower; 25° C. or lower; or 15° C. or lower. In some embodiments, a cyclopropene may be used that has boiling point at one atmosphere pressure of −100° C. or higher; −50° C. or higher; −25° C. or higher; or 0° C. or higher.

The cyclopropenes may be prepared by any method. Some suitable methods of preparation of cyclopropenes include, but are not limited to, the processes disclosed in U.S. Pat. Nos. 5,518,988 and 6,017,849.

In some embodiments, the composition may include at least one molecular encapsulating agent for the cyclopropene. In some embodiments, at least one molecular encapsulating agent may encapsulate one or more cyclopropene or a portion of one or more cyclopropene. A complex that contains a cyclopropene molecule or a portion of a cyclopropene molecule encapsulated in a molecule of a molecular encapsulating agent is known herein as a “cyclopropene molecular complex” or “cyclopropene compound complex.” In some embodiments, cyclopropene molecular complexes may comprise at least 1, 2, 3, 4, 5, 6, 7, 8, 9, 10, 20, 30, 32, 40, 50, 60, 70, 80, or 90% (w/w) of the solution.

In some embodiments, at least one cyclopropene molecular complex may be present as an inclusion complex. In such an inclusion complex, the molecular encapsulating agent forms a cavity, and the cyclopropene or a portion of the cyclopropene is located within that cavity. In some embodiments of inclusion complexes, there may be no covalent bonding between the cyclopropene and the molecular encapsulating agent. In some embodiments of inclusion complexes, there may be no ionic bonding between the cyclopropene and the molecular encapsulating agent, whether or not there is any electrostatic attraction between one or more polar moiety in the cyclopropene and one or more polar moiety in the molecular encapsulating agent.

In some embodiments of inclusion complexes, the interior of the cavity of the molecular encapsulating agent may be substantially apolar or hydrophobic or both, and the cyclopropene (or the portion of the cyclopropene located within that cavity) is also substantially apolar or hydrophobic or both. While the present invention is not limited to any particular theory or mechanism, it is contemplated that, in such apolar cyclopropene molecular complexes, van der Waals forces, or hydrophobic interactions, or both, cause the cyclopropene molecule or portion thereof to remain within the cavity of the molecular encapsulating agent.

The cyclopropene molecular complexes may be prepared by any means. In one method of preparation, for example, such complexes may be prepared by contacting the cyclopropene with a solution or slurry of the molecular encapsulating agent and then isolating the complex, using, for example, processes disclosed in U.S. Pat. No. 6,017,849. For example, in another method of making a complex in which cyclopropene is encapsulated in a molecular encapsulating agent, the cyclopropene gas may be bubbled through a solution of molecular encapsulating agent in water, from which the complex first precipitates and is then isolated by filtration. In some embodiments, complexes may be made by either of the above methods and, after isolation, may be dried and stored in solid form, for example as a powder, for later addition to useful compositions.

The amount of molecular encapsulating agent may be characterized by the ratio of moles of molecular encapsulating agent to moles of cyclopropene. In some embodiments, the ratio of moles of molecular encapsulating agent to moles of cyclopropene may be 0.1 or larger; 0.2 or larger; 0.5 or larger; or 0.9 or larger. In some embodiments, the ratio of moles of molecular encapsulating agent to moles of cyclopropene may be 2 or lower; or 1.5 or lower.

Suitable molecular encapsulating agents include, without limitation, organic and inorganic molecular encapsulating agents. Suitable organic molecular encapsulating agents include, without limitation, substituted cyclodextrins, unsubstituted cyclodextrins, and crown ethers. Suitable inorganic molecular encapsulating agents include, without limitation, zeolites. Mixtures of suitable molecular encapsulating agents are also suitable. In some embodiments, the encapsulating agent may be alpha-cyclodextrin, beta-cyclodextrin, gamma-cyclodextrin, or a mixture thereof. In some embodiments, alpha-cyclodextrin may be used. In some embodiments, the encapsulating agent may vary depending upon the structure of the cyclopropene or cyclopropenes being used. Any cyclodextrin or mixture of cyclodextrins, cyclodextrin polymers, modified cyclodextrins, or mixtures thereof may also be utilized. Some cyclodextrins are available, for example, from Wacker Biochem Inc., Adrian, Mich. or Cerestar USA, Hammond, Ind., as well as other vendors.

Embedding HAIP in a wax or resin has been previously shown to slow down water penetration. Such previous methods can be effective for relatively large particles but the scenario is different for small particles because the surface area created for small particles (a few hundred microns or less) is very large since the surface (S=4ir²) evolves to the square of the radius. One of the reasons why water can penetrate particles is that HAIP crystals distributed within the matrix are also present at the surface and create an easy entry point to the water.

In general, there are two types of particles: particles created by grinding (and thus with irregular shape) and particles created by spraying (spherical shape) (see FIG. 1). For an identical volume, the surface exposed on a perfect sphere is less than the surface of a random solid shape and should therefore be less susceptible to water penetration. Regardless of the shape, the speed at which water can penetrate a particle will also strongly depend on how fast it can percolate within the matrix. The matrix itself being water insoluble or at least water resistant (wax or resin like material), it is possible that water mostly percolates from one crystal to another and progresses within the matrix.

It appears from this initial approach that it would be difficult to adequately protect HAIP using a matrix alone (unless the spheres are near perfect and the HAIP fully embedded) when small particles and relatively high loading of HAIP are used. Provided are compositions/formulations with a coating of the particles to protect the surface to prevent/delay water penetration and slow down the overall release of the volatile compound embedded within.

Particle Coating—Modification of the particles surface properties, which is usually achieved by coating, is desirable to maintain the core properties and enhance the protection of these particles. Typically, surface modification of particles to form a barrier or film between the particle and its environment has been done by wet coating methods such as pan coaters and a variety of fluidized bed coaters or by wet chemistry-based techniques such as coacervation, interfacial polymerization and the like.

However, wet coating methods are not always desirable because of environmental concerns over VOC emissions in the case of solvents or due to sensitivity of the active ingredient. Furthermore, while coating large particles is relatively easy, coating small particles (in the micron range) is much more difficult.

Accordingly, provided is a cost-effective dry coating process using mechanical methods which exclude any liquid solvent or binder solution. Dry particle coating which directly attaches fine materials (i.e., guest particles) onto the surface of larger core particles (i.e., host particles) by mechanical means without using any solvents or binders can provide surprising superior results as compared to wet coating. One goal of the invention is to create a barrier to protect from the environment and make significant changes in the surface properties of the original/initial solid particles.

Previously disclosed dry coating methods generally allow for the application of high shearing stresses, high impaction forces to achieve coating or use heat to melt the coating to be applied. However, these previously disclosed dry coating methods are designed for large particles (e.g., tablets) and are often not appropriate for small particles.

Dry Melt Process—Provided herein is a dry melt process comprises a passive coating where small particles are applied onto the surface of larger particles by way of sticking onto a melted surface, where the cores (solid particles) are liquid or melted. In one embodiment, a coated particle generated using the dry melt process provided comprises a liquid droplet encapsulated by hydrophobic powder. The coated particle can later be cooled down to form a solid coated particle.

In one embodiment, the dry melt process provided comprises (a) mixing a melted core resin with HAIP; (b) grinding the mixture obtained into a powder with a set size; (c) mixing the powder with a smaller solid powder (coating); (d) re-melting of the core to have the coating stick to the main particles; and (e) recovering the coated particles by sieving.

The first important component of the subject invention is the core material (for example core resin) in direct contact with HAIP. The product has to be chemically inert toward HAIP and be completely free of available water. Suitable core material needs to have a melting point high enough to be workable but no so high as to generate a degradation of HAIP and also have a relatively low viscosity when melted.

Examples of suitable core materials include polymers of standard grade linear polyester diols derived from caprolactone monomer, terminated by primary hydroxyl groups. One example of such suitable core material/resin is CAPA® 2304 from Perstorp, a company located in the United Kingdom. CAPA® 2304 is a waxy solid with a typical density of 1.071, a melting point of 50-60° C. and a viscosity at 60° C. of 1050 mPas. This CAPA® 2304 resin is water insoluble to provide good protection against moisture penetration but also has a good compatibility with HAIP due to the presence of the hydroxyl groups (which tend to make the system less hydrophobic).

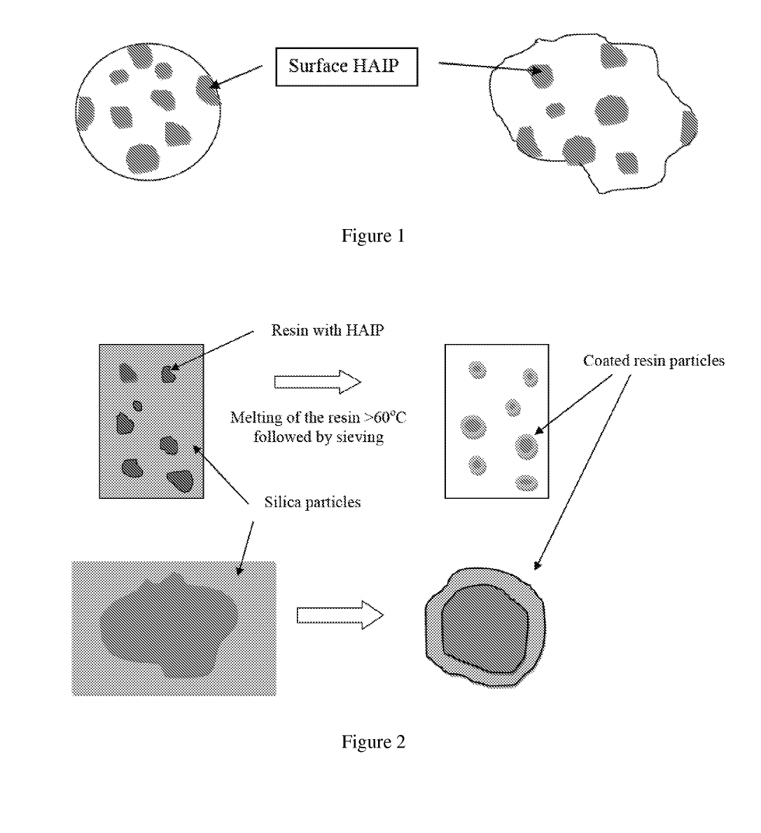

The second important component of the subject invention is powder coating (or coating particle). Regular silica alone cannot be suitable as coating particle because silica is a very light powder and is not able to support the weight of the particles when mixed together. Often the coated products sink to the bottom and fuse together upon melting instead of being separated by silica particles. However, denser silica products are sufficiently supportive to completely surround HAIP particles. FIG. 2 shows a representative dry melt coating process using dense silica particles, where the coated product has a more rounded shape after the coating process.

Particle Grinding—In one embodiment, blend of HAIP and resin is made by simply mixing HAIP in melted resin (under control heat conditions), then quickly cooling down the mixture. The resulting block of polymer is then broken down in pieces small enough to be ground to powder. A double-walled grinding chamber cooled with water through two hose adapters can be used, for example a Universal mill M20 from IKA. The powder can then be sieved to the desired size.

Suitable resins are not limited to a polymer resin with the same chemical structures or same molecule weight, but can also include blends of two or more resins. Suitable resins for use in the methods and compositions disclosed herein include, but are not limited to, polyester, polyether, epoxy resin, isocyanate, organic amine, ethylene vinyl acetate copolymer, natural or synthesized wax, and mixture thereof. In one embodiment, at least one component of the resin has an attraction, preferably a relatively strong interaction with a cyclopropene molecular complex, preferably with HAIP, which can aid in the detention of complex particles within the resin matrix. In one embodiment, the resin has a melting point below 100° C., and a viscosity below 10,000 centipoises.

In one embodiment, the resin comprises a polyester resin. One example of a suitable polyester resin is a polycaprolactone polyol (“PCL”). In various embodiments, the molecular weight of the polycaprolactone polyol is from 1,000 to 200,000; from 2,000 to 50,000; from 2,000 to 8,000; or from 2,000 to 4,000, inclusive of all ranges within these ranges. In various embodiments, the polycaprolactone polyol has a melting point from 30° C. to 120° C.; from 40° C. to 80° C.; or from 50° C. to 60° C., inclusive of all ranges within these ranges. For example, resins including PCL with molecular weight about 120,000 can have a melting point about 60° C. In one embodiment, this kind of resin with a 60° C. melting point is useful for the disclosed methods and compositions. 1-Methylcyclopropene/alpha-cyclodextrin complex (referred to herein as “HAIP”) is known to tolerate temperature about 100° C. for a short duration (for example four minutes) without significant activity loss.

In one embodiment, suitable resins may have melting point of 55° C. or higher; 65° C. or higher; or 70° C. or higher. In another embodiment, suitable resins may have melting point of 100° C. or lower; or 90° C. or lower.

Embodiments include methods of treating plants with the compositions/formulations described herein. In some embodiments, treating the plant with the composition inhibits the ethylene response in the plant. The term “plant” is used generically to also include woody-stemmed plants in addition to field crops, potted plants, cut flowers, harvested fruits and vegetables and ornamentals. Examples of plants that can be treated by embodiments include, but are not limited to, those listed herein.

In some embodiments, a plant may be treated at levels of cyclopropene that inhibit the ethylene response in the plant. In some embodiments, a plant may be treated at levels that are below phytotoxic levels. The phytotoxic level may vary not only by plant but also by cultivar. Treatment may be performed on growing plants or on plant parts that have been harvested from growing plants. It is contemplated that, in performing the treatment on growing plants, the composition may be contacted with the entire plant or may be contacted with one or more plant parts. Plant parts include any part of a plant, including, but not limited to, flowers, buds, blooms, seeds, cuttings, roots, bulbs, fruits, vegetables, leaves, and combinations thereof. In some embodiments, plants may be treated with compositions described herein prior to or after the harvesting of the useful plant parts.

The compositions/formulations described herein may be brought into contact with plants or plant parts by any method, including, for example, spraying, dipping, drenching, fogging, and combinations thereof. In some embodiments, spraying is used.

Suitable treatments may be performed on a plant that is planted in a field, in a garden, in a building (such as, for example, a greenhouse), or in another location. Suitable treatments may be performed on a plant that is planted in open ground, in one or more containers (such as, for example, a pot, planter, or vase), in confined or raised beds, or in other places. In some embodiments, treatment may be performed on a plant that is in a location other than in a building. In some embodiments, a plant may be treated while it is growing in a container such as, for example, a pot, flats, or portable bed.

Plants or plant parts may be treated in the practice of the present invention. One example is treatment of whole plants; another example is treatment of whole plants while they are planted in soil, prior to the harvesting of useful plant parts.

Any plants that provide useful plant parts may be treated in the practice of the present invention. Examples include plants that provide fruits, vegetables, and grains.

As used herein, the phrase “plant” includes dicotyledons plants and monocotyledons plants. Examples of dicotyledons plants include tobacco, Arabidopsis, soybean, tomato, papaya, canola, sunflower, cotton, alfalfa, potato, grapevine, pigeon pea, pea, Brassica, chickpea, sugar beet, rapeseed, watermelon, melon, pepper, peanut, pumpkin, radish, spinach, squash, broccoli, cabbage, carrot, cauliflower, celery, Chinese cabbage, cucumber, eggplant, and lettuce. Examples of monocotyledons plants include corn, rice, wheat, sugarcane, barley, rye, sorghum, orchids, bamboo, banana, cattails, lilies, oat, onion, millet, and triticale. Examples of fruit include papaya, banana, pineapple, oranges, grapes, grapefruit, watermelon, melon, apples, peaches, pears, kiwifruit, mango, nectarines, guava, persimmon, avocado, lemon, fig, and berries.

The present invention is further described in the following examples, which are offered by way of illustration and are not intended to limit the invention in any manner.

### EXAMPLES

### Example 1

### Release Rate Results

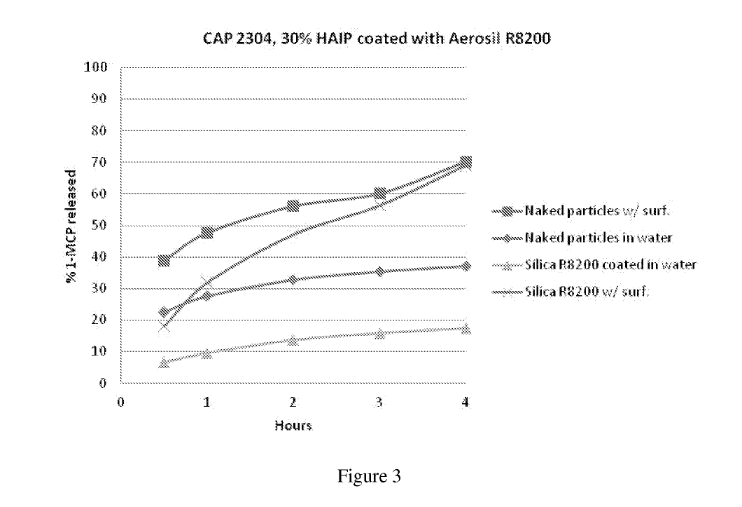

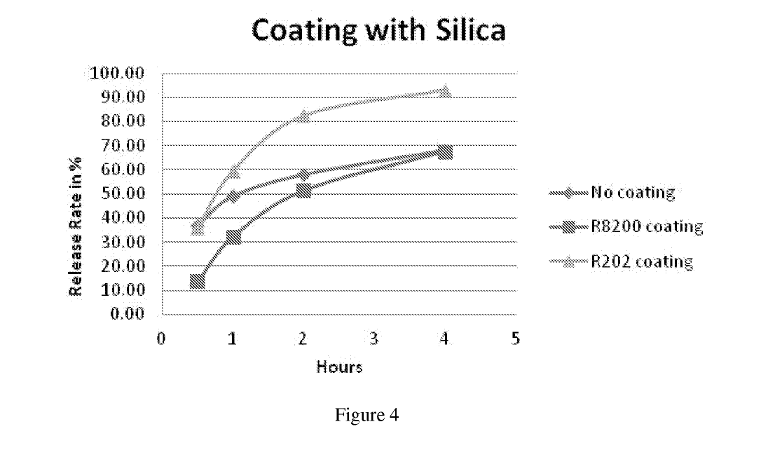

Experiment is carried out with 30% HAIP in CAPA® 2304 resin. Mesh #45 is used to ground particles to be <350 μm. Release rate over a period of four (4) hours under constant gentle shaking (multi-purpose rotator, Barnstead Lab-line on low-medium speed) is used, followed by a melting at 70° C. for one hour to entirely liberate 1-MCP. All 1-MCP is released after 55 minutes in an oven set at 70° C. One hour at 70° C. followed by 30 min shaking is used as the standard method to determine the total 1-MCP loading. The release results are shown in Table 1 and FIG. 3. Addition of 2% surfactant (for example Dawn soap from Procter & Gamble), can enhance 1-MCP release in the condition tested.

TABLE 1
Particles <350 μm with and without coating - influence of surfactant in water
Experiment 1 - sample weighed into a 250 ml bottle and 5 ml of milli Q water
and 0.25 ml cis-2-butene is added

| | % 1-MCP released in headspace | | % 1-MCP released in headspace | |
|---|---|---|---|---|
| | 51.8 mg of | Normalized vs. | 52.5 mg of | Normalized vs. |
| Elapsed Time | Sieved #45 | % total released | R8200 | % total released |
| 0.5 hour | 0.2864 | 22.58 | 0.0664 | 6.54 |
| 1 hour | 0.3492 | 27.53 | 0.0968 | 9.53 |
| 2 hours | 0.4150 | 32.72 | 0.1386 | 13.65 |
| 3 hours | 0.4477 | 35.30 | 0.1604 | 15.80 |
| 4 hours | 0.4695 | 37.02 | 0.1762 | 17.35 |
| 4 hours and | 1.2682 | 100.00 | 1.0155 | 100.00 |
| heated to 70° C. | | | | |

Experiment 2 - sample weighed into a 250 ml bottle and 5 ml of milli Q water
with 2% surfactant and 0.25 ml cis-2-butene is added

| | % 1-MCP released in headspace | | % 1-MCP released in headspace | |
|---|---|---|---|---|
| | 57.2 mg of | Normalized % | 47.5 mg of | Normalized % |
| Elapsed Time | Sieved #45 | vs. total released | R8200 | vs. total released |
| 0.5 hour | 0.4548 | 38.78 | 0.1780 | 18.09 |
| 1 hour | 0.5587 | 47.63 | 0.3132 | 31.83 |
| 2 hours | 0.6584 | 56.13 | 0.4631 | 47.06 |
| 3 hours | 0.7054 | 60.14 | 0.5538 | 56.28 |
| 4 hours | 0.8235 | 70.21 | 0.6785 | 68.96 |
| 4 hours and | 1.1729 | 100.00 | 0.9839 | 100.00 |
| heated to 70° C. | | | | |

### Example 2

### Silica Coatings

Two silica powders are tested in this Example: Aerosil® R202 and Aerosil® R8200 (Evonik Degussa Corporation Inorganic Materials, 2 Turner Place Piscataway, N.J. 08855). Both are highly hydrophobic treated silica. Aerosil® R8200 is denser and believed to be a better support of particles during the second melting (i.e., coating) process.

Aerosil® R202 is a fumed silica after treated with a polydimethylsiloxane. BET surface area is 100±20 [m²/g]. Aerosil® R202 is one of the most hydrophobic silica (hydrophobic ranking from Evonik).

Aerosil® R 8200 is a structure modified with hexamethyldisilazane after treated fumed silica. BET surface area is 160±25 [m²/g].

Release rate results in water containing 1% surfactant are shown in Table 2.

TABLE 2
Silica coatings vs. reference (no coating) at 20% HAIP loading in
CAPA ® 2304 (sample weighed into a 250 ml bottle and 5 ml
of milli Q water with 1% surfactant and 0.25 ml cis-2-butene is added)

| | | |
|---|---|---|
| | % 1-MCP released | Normalized % |
| Elapsed Time | in headspace | vs. total released |

Experiment 2-1 - Aerosil R202

| | | | |
|---|---|---|---|
| Resin = CAPA2304; | 0.5 hour | 0.4044 | 35.90 |
| 20% HAIP in resin; | 1 hour | 0.6712 | 59.59 |
| Silica = Aerosil R202; | 2 hours | 0.9293 | 82.50 |
| 59 mg | 4 hours | 1.0494 | 93.16 |
| Melting in 70° C. | 4 hours and | 1.1264 | 100.00 |
| Oven for coating | heated to 70° C. | | |

Experiment 2-2 - Aerosil R8200

| | | | |
|---|---|---|---|
| Resin = CAPA2304; | 0.5 hour | 0.1371 | 13.64 |
| 20% HAIP in resin; | 1 hour | 0.3229 | 32.14 |
| Silica = Aerosil R8200; | 2 hours | 0.5154 | 51.30 |
| 60.5 mg | 4 hours | 0.6790 | 67.59 |
| Melting in 70° C. | 4 hours and | 1.0046 | 100.00 |
| Oven for coating | heated to 70° C. | | |

Experiment 2-3 - no silica

| | | | |
|---|---|---|---|
| Resin = CAPA2304; | 0.5 hour | 0.2344 | 37.06 |
| 20% HAIP in resin; | 1 hour | 0.3095 | 48.93 |
| No silica | 2 hours | 0.3665 | 57.94 |
| Melting in 70° C. | 4 hours | 0.4309 | 68.13 |
| Oven for coating | 4 hours and | 0.6325 | 100.00 |
| | heated to 70° C. | | |

### Example 3

### Clay Coatings

Clay is initially used for providing a scaffolding support for the silica to adhere to the core particles. Surprisingly, clay by itself appears to be a suitable coating material/coating particle. Various types of organoclays are tested in this Example.

TABLE 3
Clay coatings comparison part 1 (sample weighed into a 250 ml bottle and 5
ml of milli Q water with 1% surfactant and 0.25 ml cis-2-butene is added)

| | | |
|---|---|---|
| | % 1-MCP released | Normalized % |
| Elapsed Time | in headspace | vs. total released |

Experiment 3-1 - Bentone 1000 + Aerosil R202

| | | | |
|---|---|---|---|
| Resin = CAPA2304; | 0.5 hour | 0.1811 | 22.83 |
| 20% HAIP in resin; | 1 hour | 0.2619 | 33.02 |
| Bentone 1000; | 2 hours | 0.3157 | 39.80 |
| Silica = Aerosil R202; | 4 hours | 0.3890 | 49.04 |
| 61.3 mg | 4 hours and | 0.7932 | 100.00 |
| Melting in 70° C. | heated to 70° C. | | |
| Oven for coating | | | |

Experiment 3-2 - Bentone 1000

| | | | |
|---|---|---|---|
| Resin = CAPA2304; | 0.5 hour | 0.0592 | 9.75 |
| 20% HAIP in resin; | 1 hour | 0.1004 | 16.54 |
| Bentone 1000; | 2 hours | 0.1317 | 21.70 |
| No silica; | 4 hours | 0.1793 | 29.54 |
| 61.8 mg | 4 hours and | 0.6069 | 100.00 |
| Melting in 70° C. | heated to 70° C. | | |
| Oven for coating | | | |

Bentone® 1000 is an organic derivative of bentonite clay from Elementis Specialties (Elementis Specialties, Inc. 329 Wyckoffs Mill Road, Hightstown, N.J. 08520). This rheological additive is designed for low to intermediate polarity organic systems. Experiment results with Bentone 1000 are shown in Table 3.

Bentone® 27 rheological additive is an organoclay (trialkylaryl ammonium hectorite) designed for medium to high polarity systems (from Elementis).

Bentone® 38 is an organic derivative of a hectorite clay. This rheological additive is designed for low to intermediate polarity organic systems (from Elementis).

Bentone® 34 is an organic derivative of a bentonite clay. This rheological additive is designed for low to intermediate polarity organic systems (from Elementis).

Cloisite® 30B is a natural montmorillonite modified with a quaternary ammonium salt (MT2EtOH: methyl, tallow, bis-2-hydroxyethyl, quaternary ammonium). Cloisite® 30B is an additive for plastics and rubbers to improve various physical properties, such as reinforcement, synergistic flame retardant and barrier.

TABLE 4
Clay coatings comparison part 2 (sample weighed into a 250 ml bottle and 5
ml of milli Q water with 1% surfactant and 0.25 ml cis-2-butene is added)

| | | |
|---|---|---|
| | % 1-MCP released | Normalized % |
| Elapsed Time | in headspace | vs. total released |

Experiment 3-3 - Bentone 27

| | | | |
|---|---|---|---|
| Resin = CAPA2304; | 0.5 hour | 0.1663 | 31.54 |
| 20% HAIP in resin; | 1 hour | 0.2343 | 44.43 |
| Bentone 27; | 2 hours | 0.2856 | 54.16 |
| 150-250 μm | 4 hours | 0.3618 | 68.61 |
| Melting in 70° C. | 4 hours and | 0.5273 | 100.00 |
| Oven for coating | heated to 70° C. | | |

Experiment 3-4 - Bentone 38

| | | | |
|---|---|---|---|
| Resin = CAPA2304; | 0.5 hour | 0.0920 | 13.91 |
| 20% HAIP in resin; | 1 hour | 0.1353 | 20.46 |
| Bentone 38; | 2 hours | 0.1753 | 26.50 |
| 150-250 μm | 4 hours | 0.2087 | 31.55 |
| Melting in 70° C. | 4 hours and | 0.6614 | 100.00 |
| Oven for coating | heated to 70° C. | | |

Experiment 3-5 - Cloisite 30B

| | | | |
|---|---|---|---|
| Resin = CAPA2304; | 0.5 hour | 0.0715 | 12.41 |
| 20% HAIP in resin; | 1 hour | 0.1224 | 21.25 |
| Cloisite 30B; | 2 hours | 0.1575 | 27.34 |
| 150-250 μm | 4 hours | 0.1782 | 30.93 |
| Melting in 70° C. | 4 hours and | 0.5761 | 100.00 |
| Oven for coating | heated to 70° C. | | |

Experiment 3-6 - Cloisite 93

| | | | |
|---|---|---|---|
| Resin = CAPA2304; | 0.5 hour | 0.1046 | 23.83 |
| 20% HAIP in resin; | 1 hour | 0.1497 | 34.11 |
| Cloisite 93; | 2 hours | 0.1782 | 40.60 |
| 150-250 μm | 4 hours | 0.2182 | 49.72 |
| Melting in 70° C. | 4 hours and | 0.4389 | 100.00 |
| Oven for coating | heated to 70° C. | | |

Clone® 93 is similar to 30B but with a different organic modifier (M2HT: methyl, dehydrogenated tallow ammonium). Both Closite products are from Southern Clay Products, Inc. 1212 Church Street, Gonzales, Tex. 78629.

Garamite® 1958 is an organically modified, proprietary blend of minerals. It is used as a rheological additive in adhesives and in industrial and construction sealants using unsaturated polyesters, epoxies and vinyl esters. Product is from Southern Clay Products, Inc. 1212 Church Street, Gonzales, Tex. 78629.

The release rate results with the different organoclay coatings are shown in Tables 4 and 5.

TABLE 5
Clay coatings comparison part 3 (sample weighed into a 250 ml bottle and 5 ml of
milli Q water with 1% Dawn dishwashing soap and 0.25 ml cis-2-butene is added)

| | | |
|---|---|---|
| | % 1-MCP released | Normalized % |
| Elapsed Time | in headspace | vs. total released |

Experiment 3-7 - Garamite 1958 coated

| | | | |
|---|---|---|---|
| Resin = CAPA2304; | 0.5 hour | 0.0795 | 11.29 |
| 20% HAIP in resin; | 1 hour | 0.1028 | 14.59 |
| Garamite 1958; | 2 hours | 0.1519 | 21.56 |
| Melting in 70° C. | 4 hours | 0.2081 | 29.54 |
| Oven for coating | 4 hours and | 0.7044 | 100.00 |
| | heated to 70° C. | | |

Experiment 3-8 - Bentone 34 coated

| | | | |
|---|---|---|---|
| Resin = CAPA2304; | 0.5 hour | 0.0576 | 9.04 |
| 20% HAIP in resin; | 1 hour | 0.0857 | 13.46 |
| Bentone 34; | 2 hours | 0.1061 | 16.66 |
| 150-250 μm | 4 hours | 0.1391 | 21.84 |
| Melting in 70° C. | 4 hours and | 0.6369 | 100.00 |
| Oven for coating | heated to 70° C. | | |

All references, including publications, patents, and patent applications, cited herein are hereby incorporated by reference to the same extent as if each reference is individually and specifically indicated to be incorporated by reference and is set forth in its entirety herein.

While this invention has been described in certain some embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

We claim:

1. A dry melt method, comprising:
(a) providing a melted core resin;
(b) mixing the melted core resin with active ingredient particles to generate a mixture, wherein the active ingredient comprises a volatile compound; and
(c) mixing the mixture of step (b) with particles of at least one coating material to generate a coated product.

2. The method of claim 1, further comprising grinding the mixture of step (b) into a powder with a set size; and re-melting the mixture.

3. The method of claim 2, wherein the set size is from 50 μm to 3000 μm.

4. The method of claim 1, further comprising cooling down the coated product to form a coated solid particle.

5. The method of claim 4, further comprising recovering the coated product or coated solid particle by sieving.

6. The method of claim 1, wherein the core resin is selected from the group consisting of a polyester, a polyether, an epoxy resin, an isocyanate, an organic amine, an ethylene vinyl acetate copolymer, a natural or synthesized wax, and combinations thereof.

7. The method of claim 1, wherein the core resin has a melting point from about 50° C. to 100° C.

8. The method of claim 1, wherein the active ingredient particles comprise a cyclopropene molecular complex and the cyclopropene molecular complex comprises a cyclopropene compound and a molecular encapsulating agent.

9. The method of claim 8, wherein the molecular encapsulating agent is selected from the group consisting of alpha-cyclodextrin, beta-cyclodextrin, gamma-cyclodextrin, and combinations thereof.

10. The method of claim 8, wherein the cyclopropene compound is of the formula: 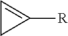
wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

11. The method of claim 10, wherein R is C₁₋₈ alkyl.

12. The method of claim 10, wherein R is methyl.

13. The method of claim 8, wherein the cyclopropene compound is of the formula: 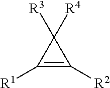
wherein R¹ is a substituted or unsubstituted C₁-C₄ alkyl, C₁-C₄ alkenyl, C₁-C₄ alkynyl, C₁-C₄ cycloalkyl, cylcoalkylalkyl, phenyl, or napthyl group; and R², R³, and R⁴ are hydrogen.

14. The method of claim 8, wherein the cyclopropene compound comprises 1-methylcyclopropene (1-MCP).

15. The method of claim 1, wherein the coating material comprises a silica particle.

16. The method of claim 1, wherein the coating material comprises an organoclay.

17. The method of claim 1, wherein the coating material comprises a combination of a silica particle and an organoclay.

18. A collection of coated solid particles prepared by the method of claim 1.

19. The collection of coated solid particles of claim 18, wherein release rate of the volatile compound after four hours upon contact of a solvent is reduced at least two folds as compared to solid particles without coating.

20. The collection of coated solid particles of claim 18, wherein release rate of the volatile compound after four hours upon contact of a solvent is reduced from two folds to five folds as compared to solid particles without coating.

21. The collection of coated solid particles of claim 18, wherein less than 25% of the volatile compound is released after four hours upon contact of a solvent.

22. The collection of coated solid particles of claim 18, wherein from 10% to 25% of the volatile compound is released after four hours upon contact of a solvent.

23. A method of treating plants or plant parts, comprising applying to the plant with a composition comprising the collection of coated solid particles of claim 18.

24. The method of claim 23, wherein the applying comprises spraying.

25. The method of claim 23, wherein the composition is a liquid composition comprising suspension of the collection of coated solid particles of claim 18.
